(19) United States
(12) Patent Application Publication
(10) Pub. No.: US 2002/0092441 A1
(43) Pub. Date: Jul. 18, 2002

(54) Phosphorescent ink composition

(76) Inventors: Yi-Jing Leu, Hsin-Chu City (TW); In-Shan Sir, Kao-Hsiung City (TW); Yu-Chang Shen, Taipei City (TW); Chia-Hsin Chien, Tao-Yuan Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 09/683,460

(22) Filed: Jan. 3, 2002

(30) Foreign Application Priority Data
Jan. 12, 2001 (TW) 090100704
Apr. 26, 2001 (TW) 090100704A01

(51) Int. Cl. C09D 11/02; C09K 11/02

(52) U.S. Cl. 106/31.6; 252/301.36

(57) ABSTRACT

A new phosphorescent ink composition including a micro-capsulated phosphorescent pigment for ink jet printing is disclosed. The phosphorescent ink composition not only promotes the printing quality, enhances light fastness of colorants, and promotes luster of color but also shows the unique luminescent colors in dark. The ink composition includes at least one phosphorescent pigment, at least one colorant providing an ink color, and a vehicle comprising an organic solvent having a predetermined concentration, and at least one surfactant. The phosphorescent pigment is micro-capsulated in a resin film and is dispersed in the vehicle. The phosphorescent pigment is ground to a diameter of less than 1 micron in advance.

### BACKGROUND OF INVENTION

1. Field of the Invention

The present invention relates to the field of luminescent ink, and more particularly, to phosphorescent ink compositions for utilization in ink jet printing. The present invention provides ink jet printing ink utilizing phosphorescent pigments that can significantly improve light fastness and luster of a phosphorescent pattern on a writing medium printed by an ink jet printer without the fear of chocking or clogging printer jet nozzle.

2. Description of the Prior Art

Luminescent pigments are generally divided into two categories according to their luminescent characteristics: fluorescent and phosphorescent. Typically, luminescence will become visible to the naked eye when luminescent pigments are activated or excited by suitable radiation. The absorption of energy from light radiation activates the pigment molecules to an excited state and then the pigment molecules start to emit fluorescent light to stabilize its energy state.

Phosphorescent pigments can absorb energy after being radiated by daylight. Different from fluorescent pigments, phosphorescent pigments can store the absorbed energy and release it in a form of visible light in the dark. The emission of light from phosphorescent pigments will persist after a time interval in a dark place.

The difference between luminescent pigments and ordinary pigments is that the ordinary pigments can change all absorbed energy to heat energy or selectively reflect light in the frequency ranges of visible light or nearly visible light. Shooting radiation or an additive effect of shooting radiation and reflecting radiation produces the color of luminescent pigments. The result is that luminescent pigments are in the additive color range and have no obvious absorbing phenomenon in the visible light spectrum. Furthermore, due to the fact that phosphor can absorb and store the energy of light from a natural or artificial light source, a luminescent effect in darkness is achieved by releasing the energy in the range of visible light.

In general, ink for colored ink jet printing is divided into magenta ink, cyan ink, yellow ink, and black ink, in which a water-based dye is mainly used. Recently, ink colors have been further divided into magenta ink, cyan ink, yellow ink, black ink, light magenta ink, light cyan ink, and light yellow ink. These compositions of ink comprise at least one water-based dye, water, an organic solvent, and other additives. However, water-resistance and light-resistance of images produced by this water-based dye ink is very poor after printing.

Therefore, in the past few years, there has been development of pigment ink with good water-resistance and light-resistance, and research on how to show the luminescent effect in colored ink jet printing. These compositions of pigment ink comprise at least one category of pigments, water, an organic solvent, and other additives. Water-resistance and light-resistance of images produced by this pigment ink is far superior to that of water-based dye ink.

In order to improve the contrast between the ink and writing media such as paper, it is desirable that the ink be fluorescent for use in certain applications such as an optical reading system. O“Brien et al. in U.S. Pat. No. 2,940,937 described the formulation of dye involving the curing of resinous material, followed by the grinding of the mass into a powder.

Various formations of ink for ink jet printing operations are known in the arts such as U.S. Pat. No. 3,994,736 issued to Hertz et al. on Nov. 30, 1976 and entitled “Ink Composition for Ink Jet Writing”, U.S. Pat. No. 3,846,141 issued to Ostergren on Nov. 5, 1974 and entitled “Jet Printing Ink Composition”, and U.S. Pat. No. 4,150,997 issued to Hayes on Apr. 24, 1979 and entitled “Water Base Fluorescent Ink for Ink Jet Printing”.

Phosphorescent pigments are also used to make various luminescent products luminescent for years. Some example products are switches, lights for carrying, articles for use in darkrooms, handrails, luminous indications such as wall indications, guidance signs, escape tools, other phosphorescent indications such as phosphorescent safety marks, ornamental articles such as ash trays, earrings and tablecloths, toys, stationery and the like. The preparations of these phosphorescent pigments are disclosed in such as U.S. Pat. No. 5,783,108 issued to Simon on Jul. 21, 1998 and entitled “Ink Composition”, and U.S. Pat. No. 5,885,483 issued to Qinglong et al. on Mar. 23, 1999 and entitled “Long Afterglow Phosphor and A Process for the Preparing Thereof”.

However, none of the prior art phosphorescent ink compositions or methods suggests or teaches the phosphorescent ink composition suitable for the use of ink jet printing operations. There are several problems for the prior art phosphorescent ink compositions to be used in ink jet printing. One major problem is printer jet nozzles clogging due to the phosphorescent pigment particle size. To not clog the nozzle of a printer, the particle size of phosphorescent pigments has to be made as small as possible. Typically, the printer nozzle diameter is from 30 to 50 microns. Therefore, a suitable phosphorescent pigment particle size should be less than 1 micron (diameter). Large particulate materials in the ink composition could plug the orifice when the printer is not in use. The second problem of the prior art ink compositions is the insufficient light fastness and/or lightproof ability. Further, the hydrophilic property of the prior phosphorescent pigments also limited their application in the ink jet printing.

### SUMMARY OF INVENTION

It is therefore a primary objective of the claimed invention to provide an ink composition comprising a phosphorescence pigment for colored ink jet printing, that can not only promote the printing quality, enhance light fastness of colorants, and promote a luster of colors, but also show the particular luminescent colors in the dark.

According to the claimed invention, the ink composition comprises at least one phosphorescent pigment, at least one colorant providing an ink color, and a vehicle comprising an organic solvent having a predetermined concentration, and at least one surfactant. The phosphorescent pigment is micro-capsulated in a resin film and is dispersed in the vehicle. The phosphorescent pigment is ground to a diameter of less than 1 micron.

It is an advantage of the claimed invention that the new phosphorescent ink composition significantly improves light fastness of a phosphorescent pattern on a writing medium printed by an ink jet printer. In addition, the composition also allows the unique luminescent colors to be seen in the dark. Finally, by keeping the diameter of the phosphorescent pigment under 1 micron, there is no fear of clogging the printer jet nozzle.

These and other objectives and the advantages of the present invention will no doubt become obvious to those of ordinary skill in the art after having read the following detailed description of the preferred embodiment.

### DETAILED DESCRIPTION

The present invention provides a new phosphorescent ink composition suitable for the use in an ink jet printing system. The ink composition according to the present invention comprises a colorant, a liquid vehicle, and a phosphorescent pigment that is micro-capsulated by a resin film and dispersed in the liquid vehicle.

The vehicle comprises an organic solvent such as ethylene glycol, diethylene glycol, triethylene glycol, 2-pyrrolidone, propylene glycol, butylene glycol, pentylene glycol, N-methyl-2-pyrrolidone and the like. In another embodiment according to the present invention the vehicle further comprises water having a content preferably ranging from 65% to 85% by weight based on the ink composition.

The colorant may be water or solvent soluble dye such as magenta dye, cyan dye, yellow dye, black dye, light magenta dye, light cyan dye, light yellow dye etc. Other ingredients, which may be optionally used, include polybutyl resins, cellulose derivatives, styrene/acrylic copolymer resins, maleic acid/styrene copolymers, or a polymer comprises hydrophilic segment and hydrophobic segment. These additional components may be used to enhance either the surface tension property or adhesion ability of the ink.

The phosphorescent pigment may be made from zinc cadmium sulfide, calcium strontium sulfide, rare earth metal compounds and the like. A preferred zinc cadmium sulfide is expressed by a general formula nZnS(1−n)CdS:Cu, where n is 0.78˜1.0, and the composition of Cu is about 0.01% by weight. A preferred calcium strontium sulfide is expressed by a general formula nCaS(1-n)SrS:Bi, Cu, where n is 0˜1.0 (the color shifts from blue to green), the composition of Bi is about 0.04% by weight, and the composition of Cu is about 0.01% by weight. Note that the phosphorescent pigment is micro-capsulated by a resin film demonstrating a pigment particle diameter of less than 1 micron. The micro-capsulated phosphorescent pigment is dispersed in the liquid vehicle by using a dispersing agent known in the art.

Either water base phosphorescent ink composition or organic solvent base phosphorescent ink composition can be adopted for high-speed ink jet printing according to the present invention. The water base phosphorescent ink composition comprises 0.1˜20% phosphorescent pigments and the preferable range is from 3% to 5%, 5.0% colorants, 5.0% surfactants, 1.0˜20% organic solvent, 65˜85% water, an acid-base buffer, a chelating agent, a bactericide, and a preservative. The organic solvent base phosphorescent ink composition comprises 0.1˜20% phosphorescent pigments, 5.0% colorants, 5.0% surfactants, 65˜90% organic solvent, an acid-base buffer, a chelating agent, a bactericide, and a preservative.

Preparation of phosphorescent inks according to the present invention may be further demonstrated by the following examples. However, these examples are not intended to limit the scope of the present invention. All percentage units are by weight unless otherwise noted.

### EXAMPLE 1

A water base phosphorescent ink composition comprises a 0.1˜20% micro-capsulated phosphorescent pigment, a 5.0% colorant, a 5.0% surfactant, a 5.0% organic solvent, 65˜85% water, an acid-base buffer, a chelating agent, a bactericide, and a preservative. As a matter of environmental concern, the concentration of the organic solvent in the water base phosphorescent ink composition is suggested below 10%, preferably between 5%˜7%.

The phosphorescent pigments of this invention have an average diameter less than 1.0 μm. The phosphorescent pigments are first ground to less than 1.0 μm by methods known in the art and then admixed with resin to form micro-capsules. The related prior art referring to micro-grain dispersion can be found in U.S. Pat. No. 4,150,997. Since the phosphorescent pigments of this invention have diameters less than 1.0 μm, it can overcome nozzle-clogging problems as mentioned.

A luminescence test for the water base ink is also implemented according to different weight percentage of the phosphorescent pigments such as 0.1%, 0.5%, 1.0%, 2.5%, 5.0%, 7.5%, 10%, 15%, and 20% etc. The results demonstrate good luminescent ability of the phosphorescent ink that, after exposing to suitable radiation for minutes, the luminescence lasts for one hour and even more. The new phosphorescent ink according to the present invention also shows good light fastness and is very lightproof. Since the phosphorescent pigments are micro-capsulated by resin, the ink composition demonstrates superior chemical stability. After a long time use, the nozzle jet of the printer is not clogged.

### EXAMPLE 2

The second phosphorescent pigment ink composition of this invention is a solvent base ink which comprises 0.1˜20% phosphorescence pigments, 5.0% colorants, 5.0% surfactants, 65˜90% organic solvent, an acid-base buffer, a chelating agent, a bactericide, a preservative and other additives. No water is added.

The above disclosure is not intended as limiting. Those skilled in the art will readily observe the numerous modifications and alterations of the device may be made while retaining the teachings of the invention. Accordingly, the above disclosure should be construed as limited only by the metes and bounds of the appended claims.

What is claimed is:

1. An ink composition for ink jet printing operations, the ink composition comprising:
at least one phosphorescent pigment;
at least one colorant providing an ink color; and
a vehicle comprising an organic solvent and at least one surfactant;
wherein the phosphorescent pigment is micro-capsulated in a resin film and is dispersed in the vehicle.

2. The ink composition of claim 1 wherein the vehicle is a water-based solution.

3. The ink composition of claim 2 wherein the content of water in the ink composition is from 65% to 85% by weight.

4. The ink composition of claim 1 wherein the vehicle is a solvent-based solution.

5. The ink composition of claim 4 wherein the content of organic solvent in the ink composition is from 65% to 90% by weight.

6. The ink composition of claim 1 wherein the colorant comprises pigments.

7. The ink composition of claim 1 wherein the colorant comprises dye.

8. The ink composition of claim 1 wherein the phosphorescent pigment has a diameter that is less than 1.0 μm.

9. The ink composition of claim 1 wherein the vehicle further comprises an additive selected from the group consisting of acid-base buffers, chelating agents, bactericides, and preservatives.

10. The ink composition of claim 1 wherein the content of the phosphorescent pigment is within the range of from 0.1% to 20% by weight, the content of the colorant is within the range of from 1% to 20% by weight, the content of the organic solvent is within the range of from 1% to 20% by weight, and the content of the surfactant is within the range of from 1% to 20% by weight.

11. A method for ink jet printing comprising:
providing an ink jet ink comprising:
at least one phosphorescent pigment;
at least one colorant providing an ink color; and
a vehicle comprising an organic solvent and at least one surfactant;
jetting the ink onto a medium;
wherein the phosphorescent pigment is encapsulated in a resin film to form a micro-capsule having a diameter of less than 1 μm spread through the vehicle.

12. The method of claim 11 wherein the colorant is selected from the group consisting of magenta colorants, cyan colorants, yellow colorants, black colorants, light magenta colorants, light cyan colorants, and light yellow colorants.

13. The method of claim 11 wherein the vehicle is a water-based solution.

14. The method of claim 13 wherein the content of water in the ink composition is from 65% to 85% by weight.

15. The ink composition of claim 11 wherein the vehicle is a solvent-based solution.

16. The ink composition of claim 15 wherein the content of organic solvent in the ink composition is from 65% to 90% by weight.

17. The method of claim 11 wherein the colorant comprises pigments.

18. The method of claim 11 wherein the colorant comprises dye.

19. The method of claim 11 wherein particles of the phosphorescent pigment has a diameter that is less than 1.0 μm.

20. The method of claim 11 wherein the vehicle further comprises an additive selected from the group consisting of acid-base buffers, chelating agents, bactericides, and preservatives.

21. The method of claim 11 wherein the content of the phosphorescent pigment is within the range of from 0.1% to 20% by weight, the content of the colorant is within the range of from 1% to 20% by weight, the content of the organic solvent is within the range of from 1% to 20% by weight, and the content of the surfactant is within the range of from 1% to 20% by weight.
